(19) United States
(12) Patent Application Publication
(10) Pub. No.: US 2007/0025514 A1
(43) Pub. Date: Feb. 1, 2007

(54) X-ray arrangement for graphic display of an object under examination and use of the x-ray arrangement

(76) Inventor: Ruediger Lawaczeck, Berlin (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/446,515

(22) Filed: Jun. 5, 2006

Related U.S. Application Data
(60) Provisional application No. 60/689,057, filed on Jun. 10, 2005.

(30) Foreign Application Priority Data
Jun. 6, 2005 (DE) 102005026940.0

(51) Int. Cl. H05G 1/64

(52) U.S. Cl. 378/98.9

(57) ABSTRACT

For high-contrast visualization of small lesions or other target areas in tissue that contains at least one opacifying chemical element in the human body, an x-ray arrangement is described that comprises at least one x-ray radiation source that emits essentially polychromatic x-ray radiation, a first detector or several first detectors, with which values of a first intensity of the x-ray radiation that is transmitted through the object under examination can be determined, a second detector or several second detectors, with which values a second intensity of the x-ray radiation that is emitted from the object under examination can be determined, at least one correlation unit, with which the first intensity values of the transmitted x-ray radiation can be correlated with one another with the second intensity values of the emitted x-ray radiation, pixel for pixel, and at least one output unit for visualizing the object under examination from the pixel signals that can be obtained by correlation of the first intensity values with the second intensity values. The transmission and emission images are preferably recorded simultaneously. The process can also be combined with other radiological images, e.g., from the positron-emission tomography (PET) or single-photon-emission-computer tomography (SPECT).

This application claims the benefit of the filing date of U.S. Provisional Application Ser. No. 60/689,057 filed Jun. 10, 2005.

### DESCRIPTION

This invention relates to an x-ray arrangement for graphic display of an object under examination that contains at least one radiopaque chemical element by means of x-ray radiation, a use of the x-ray arrangement as well as an imaging x-ray contrast process on an object under examination, for example a mammal, especially a human.

The medical diagnosis with the aid of x-ray radiation is a technically highly-developed field for diagnosis of diseases, for example for early detection, for radiographic identification, for characterization and for location of tumors, vascular diseases and other pathological changes of the human body. The technique is very efficient and exhibits high availability.

To produce x-ray radiation, x-ray tubes, for example with W-, Mo- or Rh-rotating anodes and Al-, Cu-, Ti-, Mo- and Rh filters, are available. With suitable filtration, a portion of the bremsstrahlung is filtered out, such that in advantageous cases, essentially the characteristic radiation emerges from the x-ray tubes.

As detectors, either conventional x-ray films, digital plates or digital flat-bed detectors are used. In computer tomographs, a detector line or several detector lines are used. Also, several detectors can be connected in parallel. For direct conversion of x-ray radiation into electric signals, semiconductor detectors that consist of cadmium-telluride (CT), cadmium-zinc-telluride (CZT), amorphous salts or amorphous or crystalline silicon are used (M. J. Yaffe, J. A. Rowlands, “X-Ray Detectors for Digital Radiography,” Med. Biol., 42(1) (1997) 1-39).

An example of the design of such detectors is indicated in U.S. Pat. No. 5,434,417 A. To also make possible an energy sensitivity of the detector, the latter is formed from several layers. X-Ray radiation with different energy is drawn through in different depths in this detector and produces an electric signal in the respective layer by photoelectric effect, which can be read out according to the layer and thus according to the energy of the x-ray photons, immediately identifiable as a current impulse.

Computer tomography (CT) has already been used for a long time as a routine process in regular clinical practice. With CT, sectional images through the body are obtained, with which a better spatial resolution is achieved than with the conventional projection radiography. Although the density resolution of the CT is also clearly higher than the density resolution of the conventional x-ray technology, contrast media are still required for reliable detection of many pathological changes. The latter improve the quality of the morphological information. In this case, on the one hand, fuinctional processes are visualized in the body through the contrast medium (excretion, perfusion, permeability), and on the other hand, the morphology is emphasized by the provision of contrasts (different contrast medium concentrations in various tissues).

In many cases, the conventional x-ray technology could not be used, since the contrast of the tissue to be examined was not adequate. For this purpose, x-ray contrast media were developed that produce a high radiographic density in the tissue in which they accumulate. Typically, iodine, bromine, and elements of atomic numbers 34, 42, 44-52, 54-60, 62-79, 82 and 83 are proposed as opacifying elements as well as the chelate compounds of the elements with atomic numbers 56-60, 62-79, 82 and 83. As iodine compounds, for example, meglumine-Na- or lysine-diatrizoate, iothalamate, ioxithalamate, iopromide, iohexol, iomeprol, iopamidol, ioversol, iobitridol, iopentol, iotrolan, iodixanol and ioxilan (INN) can be used (EP 0 885 616 A1).

In some cases, despite the administration of x-ray contrast media, no adequate tissue contrast could be achieved. To achieve an additional increase in the contrast, digital subtraction angiography (DSA) was introduced, in which pre- and post-contrast images (logarithmic) are subtracted from one another. A subtraction method for use in mammography is disclosed in EP 0 885 616 A1: For projection mammography, it is proposed there first to record a pre-contrast mammogram, then the patient is to be quickly injected i.v. with a commonly used urographic x-ray contrast medium, and a post-contrast mammogram is to be recorded about 30 seconds to 1 minute after the end of the injection. The data that are obtained from the two images are then correlated with one another, preferably subtracted from one another.

New developments in the field of CT relate to the excitation side, for example, the use of synchrotron radiation in CT (F. A. Dilmanian, “Computed Tomography with Monochromatic X-Rays,” Am. J Physiol. Imaging, 314 (1992) 175-193). Good x-ray images are obtained, for example, by means of “K-Edge Subtraction CT” (F. A. Dilmanian, op. cit., page 179), whereby the strong increase of the absorption coefficient in the binding energy of the K-electron of an atom is used. The element iodine has a K-edge at an energy of 33.17 keV. Unfortunately, this process works only with the aid of the synchrotron radiation that is available to large storage rings, such as, for example, with DESY, since only this radiation has the monochromasia and intensity that are advantageous for the process. Conventional x-ray tubes do not yield any monochromatic radiation but rather a continuous spectrum. They are therefore not readily suitable for such measurements of difference.

An alternative possibility is described in DE 101 18 792 A1: Here, to record projection mammograms, a process is proposed in which x-ray radiation sources with two x-ray anodes made of different materials are used. To record the mammogram, first an x-ray contrast medium is administered to the patient. Then, a first projection image is recorded with use of the first of the two x-ray anodes and then a second projection image is recorded with use of a second x-ray anode. By the superposition of each individual pixel from the first image with each individual corresponding pixel from the second image, a correlation image is then created. The characteristic radiation of the two x-ray anodes is matched to the absorption spectrum of the x-ray contrast medium: the emission energy of the first x-ray anode lies slightly below the absorption energy of the opacifying element in the x-ray contrast medium, and the emission energy of the second x-ray anode lies slightly above the absorption energy of the opacifying element. A drawback of this process consists in the fact that conventional x-ray tubes must be replaced with only one x-ray anode from bi-anode tubes.

In addition, for transmission radiography, an emission radiography is also described:

Thus, in WO 2004/041060 A2, a device for non-invasive in-vivo determination of a chemical element in the prostate of a human that has a probe, an irradiation system with which the chemical element can be excited to produce the emission of radiation, a radiation detector within the probe with which the emitted radiation can be imaged, as well as a signal recording, processing and display system, with which the amount of the chemical element in the prostate can be reproduced at various spots corresponding to the imaging of the emitted radiation, is described. The emitted radiation essentially consists of fluorescence radiation. In the case of the study of the prostate, preferably the distribution of Zn in the tissue is determined.

In addition, in DE 36 08 965 A1, a process for determining the proportion of various chemical elements in one layer of an area of examination by means of gamma or x-ray radiation is described. In this case, the Compton and the Rayleigh scattered radiation are detected separately. The course of the differential scatter coefficients determined from the measured values is influenced by the proportions of various chemical elements contained in the individual pixels. The proportion of these chemical elements can therefore be determined from them. To this end, out of a number of directions, a primary beam is drawn through the area of examination, and the radiation that exits from the area of examination under various angles is detected by a detector arrangement in various positions outside of the area of examination, after which the differential scatter coefficient for various pulse transfers is determined from the measured values for each pixel of the layer that are obtained in this case.

Also, Quanwen, Yu et al., “Preliminary Experiment of Fluorescent X-Ray Computed Tomography to Detect Dual Agents for Biological Study” in: J. Synchrotron Rad. (2001), 8, 1030-1034 proposed the use of the x-ray fluorescence method for determining very low concentrations of non-radioactive substances in biomedical studies. By means of these methods, images can be obtained with which multiple agents can be detected simultaneously with use of the fluorescence-K_{α} line in a single study to detect quantitatively, for example, the flow of blood in the brain and the density of the brain cells. In the presented study, images generated by means of these methods were compared to images obtained by means of x-ray transmission tomography.

The x-ray fluorescence or x-ray scattered light method described in the publications indicated above has the drawback, however, that a visualization in small details of an object under examination is not easily possible because of difficulties in the imaging. Rather, only highly resolved visualizations are obtained, such that smaller details are very difficult to visualize graphically.

The problem of this invention is therefore to avoid the above-mentioned drawbacks and to find in particular arrangements and processes with which images can be produced with different radiopaque chemical elements. Further, the x-ray images are also to be able to be recorded in a simple, easy way, without high costs resulting. The technology is to be available on a broad basis. Also, smaller lesions in the object under examination are to be able to be made visible with the smallest possible radiation dose with high site resolution. Artifacts of movement are to be avoided.

This problem is solved by the x-ray arrangement for imaging an object under examination that contains at least one radiopaque chemical element by means of x-ray radiation according to claim 1, the use of this x-ray arrangement according to claim 11, and the imaging x-ray contrast process according to claim 25. Preferred embodiments of the invention are indicated in the subclaims.

If the terms “emission” and “emitting” are used in the description of the invention and in the claims below, they are to be understood to include, on the one hand, x-ray fluorescence, i.e., the emission of radiation after an excitation of the irradiated matter by means of electromagnetic radiation, and, on the other hand, preferably Rayleigh radiation. In the latter case, the radiation is emitted again without pulse transfer from the irradiation matter, whereby, however, no excitation of orbital electrons in atoms of this matter into excited states takes place as in the case of fluorescence because of the irradiation.

With the x-ray arrangement, x-ray radiation that is transmitted for graphic display through the object under examination and that is emitted from the latter is used. To this end, the x-ray arrangement according to the invention has the following features:
a. At least one x-ray radiation source that emits essentially polychromatic x-ray radiation,
b. A first detector or a first detector unit (a unit that consists of several detectors that are connected and/or arranged in parallel), with which values of a first intensity of the x-ray radiation that is transmitted through the object under examination can be determined,
c. A second detector or a second detector unit, with which values a second intensity of the x-ray radiation that is emitted from the object under examination can be determined,
d. At least one correlation unit, with which the first intensity values of the transmitted x-ray radiation can be correlated with one another with the second intensity values of the emitted x-ray radiation, pixel for pixel, and
e. At least one output unit for visualizing the object under examination from the pixel signals that can be obtained by correlation of the first intensity values with the second intensity values.

The transmitted x-ray radiation and the emitted x-ray radiation can be detected either simultaneously or in succession.

This x-ray arrangement can advantageously be used for the graphic display of an object under examination that preferably contains at least one radiopaque chemical element by means of x-ray radiation. The radiopaque chemical element is preferably introduced by an x-ray contrast medium into the object under examination, and, for example, administered to this end to the object under examination, for example a human or an animal.

The opacifying chemical elements with low atomic numbers that occur naturally in an object under examination have only a small yield of x-ray fluorescence, such that the imaging with use of these elements does not appear to be practicable. In addition, the energy of the x-ray fluorescence photons is low in this case, such that even their range of action in the body tissue is low. In particular, starting from the element iodine (Z=53) with the emission lines 28.6 and 32.3 keV, fluorescence lines are available that leave the object under examination to a sufficient extent and thus can be recorded by a detector arranged outside of the object. In the case of a lower atomic number of the chemical element, an arrangement of the second detector can be selected in which the latter is arranged as close as possible to the area to be examined (ROI: Region of Interest).

The x-ray arrangement is used to perform the x-ray contrast process according to the invention. The process has the following process steps:
a. Preferably administration of at least one radiopaque chemical element,
b. Irradiation of the object under examination with essentially polychromatic x-ray radiation,
c. Determination of values of a first intensity of the x-ray radiation that is transmitted through the object under examination,
d. Determination of values of a second intensity of the x-ray radiation that is emitted by the object under examination,
e. Correlation of the first intensity values of the transmitted x-ray radiation, pixel for pixel, with the second intensity values of the emitted x-ray radiation,
f. Visualization of the object under examination from pixel signals that are obtained by correlation of the first intensity values with the second intensity values.

In contrast to the known processes, in which either only the x-ray transmission tomography (TXCT) is performed or only the x-ray fluorescence (FXCT) is detected, transmission and the emission are measured here simultaneously or in succession, and these two techniques are combined with one another according to this invention, whereby the images that are obtained respectively in this case are superimposed by a suitable correlation process. In this procedure, the respective advantages of both techniques are used:

The x-ray transmission tomography namely offers the advantage of a high achievable temporal and spatial resolution, such that in principle, the smallest lesions or other details can also be resolved in a human body that has been examined. However, the contrast that is obtained frequently is not sufficient also to make these details visible. This applies in particular for tests of lesions in soft tissue. In addition, examinations of certain body regions with the TXCT process are also hampered by the skeleton.

In contrast, the x-ray fluorescence tomography offers the advantage of an extraordinarily high-contrast visualization, since only certain chemical elements emit electromagnetic radiation with suitable excitation of these elements, so that these elements that are found in the area of examination (ROI) are suitable as extremely sensitive measuring probes. The FXCT method, however, suffers from the drawback of a low spatial resolution, such that smaller lesions can no longer be visualized.

Only by the correlation of the intensity values of the transmitted x-ray radiation, pixel for pixel, with the intensity values of the emitted x-ray radiation and the visualization of the object under examination from pixel signals that had been obtained by this correlation can a high-contrast and detailed image of the area under examination (ROI) be produced. The opacifying image portion has namely a low resolution. By the correlation of the respective values with one another, this deficiency, however, is remedied to a great extent, since the necessary detailed information originates from the intensity values of the radiation that is measured by means of TXCT.

The invention can be used in particular for examining humans. The invention is suitable for producing radiographs for visualizing masses, vessels and perfusion, for example for visualizing the esophageal-gastrointestinal passage, for bronchiography, chloegraphy, angiography and cardiac angiography, for cerebral angiography and for perfusion measurements, for mammography as well as for lymphography. The focus in the application engineering of the invention lies in computer tomography (MS-CT; μCT), and their fusion modalities (PET-CT (positron-emission tomography), SPECT (Single-Photon-Emission-Computer Tomography), sonography and with other methods of optical imaging). In principle, the invention can also be used to study non-living materials, for example in the field of materials testing.

To perform an examination, the transmitted radiation is recorded by means of the first detector, which is found in the beam path of the x-ray tubes attenuated by the object under examination. The emitted radiation is measured by means of the second detector, which is arranged outside of this beam path, preferably at an angle of about 90° to the beam path. This second detector can in principle also be arranged, however, in any other angular position to the x-ray beam, for example 45° or 135° to the beam starting from the x-ray radiation source, without, however, it being detected by the beam being drawn through the object under examination. If the x-ray tubes are found in the 12 o'clock position, ordinary computer tomographs are equipped with a series of detectors at the opposite 6 o'clock position. The second detector can preferably be arranged in the 3 o'clock position and/or the 9 o'clock position. By means of this second detector, both x-ray fluorescence and x-ray scatter (Rayleigh scatter, Compton scatter) can be recorded.

For selective detection of images with the second detector with use of the emitted x-ray radiation, the energy of the emitted x-ray radiation can be measured in resolved form. In the presence of a pre-established emitting chemical element in the object under examination, it is especially advantageous to discriminate the x-ray radiation that is recorded by the second detector and that originates from this opacifying element from another emitted x-ray radiation, for example from scattered radiation (Compton radiation, Rayleigh radiation) and fluorescence radiation originating from other chemical elements. It is thus made possible to make certain areas (ROI) very selectively visible by, for example, building up the concentrations of opacifying chemical elements in certain organs of a human body, such that an especially high contrast of the tissue that is made visible compared to the surrounding tissue is produced. Also, the structure in a graphic display that is produced from the skeleton is less prominent in such a case compared to the visualization of the tissue, so that the skeleton leaves the graphic display virtually undisturbed.

To detect and characterize the emission radiation, preferably an energy-dispersive detector is used. It is also possible, however, to use simpler detectors for this purpose, and to ensure the characterization of the emission by x-ray-optical modules (filter combination, monochromators).

In addition, this principle can be applied in the same way to the measurement of the intensity values of the transmitted x-ray radiation with the first detector. Also, in this case, a selective visualization of the areas in the object under examination (ROI) is achieved, in which the opacifying chemical elements are concentrated.

Therefore, soft tissues, for example in the human, can also be visualized in high contrast with the invention. By coordinating the energy or the energy interval of the transmitted and emitted x-ray radiation that is recorded by the detectors with the type of opacifying chemical element, an efficient increase in contrast compared to conventional processes can be achieved.

To generate the x-ray radiation, a normal, commercially available x-ray tube with a continuous spectrum can be used, for example a tube with an Mo, W or Rh anode. Depending on the type of opacifying chemical element that is contained in the object under examination, a voltage is applied that makes possible an emission of the continuous radiation in the.range of up to, for example, over 100 keV.

In principle, the x-ray radiation source can be operated without filtering the emitted radiation, such that polychromatic radiation occurs in the entire spectral range on the object under examination. To reduce the radiation exposure of the object under examination, however, it is also possible to filter out such x-ray radiation from the spectrum of the polychromatic x-ray radiation source, whose energy is not necessary or is not advantageous for the detection. To this end, for example, an Al or a Cu filter is used, which filters out energy in the range of ≦20 keV (soft radiation). Defined as a continuous spectrum is thus an x-ray emission in a range of ≧0 keV, preferably ≧15 keV, especially preferably ≧17 keV, and quite especially preferably ≧20 keV, up to, for example, 100 keV, whereby no spectral range within these limits compared to others is emphasized or excluded. The upper limit of the emission spectrum is determined by the voltage that is applied to the x-ray anode. The low-energy range of the radiation is preferably filtered out to eliminate the dose-relevant radiation for the human body.

Normally, the object under examination is examined with polychromatic x-ray radiation with a suitable detector. Optionally, an energy-dispersive detector can also be used to determine the energy of the incident photons.

As energy-dispersive detectors and detector units, in principle two designs are available:
a. Energy-dispersive detectors according to the type of Cd(Zn)Te detectors, as described in the introduction of the description. With such a series of detectors, x-ray spectra of the emitted x-ray radiation can be measured pixel for pixel.
b. Simple x-ray detectors are used. A discriminator, which in the simplest case consists of a suitable filter combination, is arranged in front of the detector. For energy selection, however, monochromators that are adjusted to, for example, the x-ray fluorescence of the administered contrast medium, can also be used.
c. It is also definitely technically possible, however, to adapt the detector directly to the contrast medium. Thus, Gd(Zn)Te detectors or Dy(Zn)Te detectors can be used.

In all cases, the detector is positioned as much as possible so that a minimum of the Compton scatter is measured.

To determine the values of the intensity as well as the energy of the x-ray radiation emitted by the object under examination, the detected photons are divided into at least two different energy ranges, which contain, for example, the K_{α} and the K_{B} emission lines. To increase the element specificity, a Compton correction optionally can be performed. As the examples further indicated below show, this is not always necessary, however.

If a native x-ray contrast is ignored, an x-ray contrast medium can be administered to the object under examination, for example a human, to perform the process according to the invention. The x-ray contrast medium can be administered, for example, enterally or parenterally, especially by i.v., i.m. or subcutaneous injection or infusion. Then, the x-ray image is made. Those contrast media that exhibit high attenuation coefficients in the selected spectral area per se are suitable. Contrast media whose absorbing element has the K-edge of the absorption spectrum in the selected spectral range are also especially suitable. Such x-ray contrast media contain opacifying chemical elements with an atomic number of 35 or greater than 35—in this case, for example, this is a contrast medium that contains bromine—with an atomic number of 47 or greater than 47—in this case, this is a contrast medium that contains iodine—, with an atomic number of 57 or greater than 57—in this case this is a contrast medium that contains lanthanides, especially a contrast medium that contains gadolinium—or with an atomic number of 83—in this case this is a contrast medium that contains bismuth. Therefore, x-ray contrast media that contain opacifying chemical elements with an atomic number of 35 (bromine) to 83 (bismuth) are suitable. Especially suitable are contrast media with opacifying chemical elements with an atomic number of 53 (iodine)-83 (bismuth). Also suitable are x-ray contrast media with opacifying chemical elements with an atomic number of 57 or greater than 57 (lanthanides)-83 (bismuth) and especially preferably media with opacifying chemical elements with an atomic number of 57-70 (lanthanides: La, Ce, Pr, Nd, Pm, Sm, Eu, Gd, Tb, Dy, Ho, Er, Tm, and Yb).

Suitable iodine-containing x-ray contrast media are, for example, compounds that contain triiodine aromatic compounds, such as, for example, amidotrizoate, iohexol, iopamidol, iopanoic acid, iopodinric acid, iopromide, iopronic acid, iopydone, iothalamic acid, iopentol, ioversol, ioxaglat, iotrolan, iodixanol, iotroxic acid, ioxaglic acid and ioxithalamic acid and iosimenol (INN). Trade names for x-ray contrast media that contain iodine are Urografin® (Schering), Gastrografin® (Schering), Biliscopin® (Schering), Ultravist® (Schering) and Isovist® (Schering).

Also suitable as x-ray contrast media are metal complexes, for example Gd-DTPA (Magnevist® (Schering)), Gd-DOTA (Gadoterate, Dotarem), Gd-HP-DO3A (Gadoteridol, Prohance® (Bracco)), Gd-EOB-DTPA (Gadoxetat, Primavist), Gd-BOPTA (Gadobenat, MultiHance), Gd-DTPA-BMA (Gadodiamide, Omniscan® (Amersham Health)), Dy-DTPA-BMA, Gd-DTPA-polylysine, and Gd-DTPA-cascade polymers, i.a., whereby DTPA=diethylenetriaminepentaacetic acid, DOTA=1,4,7,10-tetraazacyclododecane, HP-D03A=10-(hydroxypropyl)-1,4,7,10-tetraazacyclododecane-1,4,7-triacetic acid), EOB-DTPA=3,6,9-triaza-3,6,9-tris(carboxymethyl-4-(4-ethoxybenzyl)undecanedicarboxylic acid, BOPTA=(4-carboxy-5,8,11-tris(carboxymethyl)-1-phenyl-2-oxa-5,8,11-triazatridecan-13-oic, benic acid), DTPA-BMA=diethylenetriaminepentaacetate-bis(methylamide), DTPA-polylysine=diethylenetriaminepentaacetate-polylysine, DTPA-cascade polymers.

The x-ray contrast media can be administered enterally and parenterally. In the case of parenteral administration, the intravenous (i.v.) administration is preferably selected. Preferred dosages are doses up to 0.75 g of I/kg of body weight in the iodine-containing non-ionic contrast media. This corresponds to approximately 6 mmol of I/kg of body weight. In addition, the dose can preferably be increased to 1.5 g of I/kg of body weight (corresponding to approximately 12 mmol of I/kg of body weight) and in exceptional cases up to 2 (corresponding to approximately 16 I) or 5 g of I/kg of body weight (corresponding to approximately 39 mmol of I/kg of body weight). In the case of the lanthanide complexes, the preferred dose is approximately 0.1 mmol/kg of body weight. Doses up to 0.3 mmol/kg of body weight or up to 1 mmol/kg of body weight are suitable and, in addition, also preferred.

The emission lines of gadolinium are approximately 43.0 and 48.7 keV, i.e., far above the emission lines of iodine, which are approximately 28.6 and 32.3 keV. Instead of the gadolinium atoms, the metal complexes can also contain, for example, all other lanthanides, such as lanthanum, dysprosium or ytterbium.

Digital detectors have already been offered for some time by various manufacturers (for example: The BBI Newsletter, February 1999, page 34; H. G. Chotas, J. T. Dobbins, C. E. Ravin, “Principles of Digital Radiography with Large-Area, Electronically Readable Detectors: A Review of the Basics,” Radiol., 210 (1999) 595-599). They often consist of amorphous silicon or other semiconductor materials. In the x-ray arrangement according to the invention, i.a., the following detectors are suitable: detectors with phosphorus plates (for example from Fuji Chemical Industries, Konica), with amorphous silicon (for example from GE Medical, Philips Medical, Siemens Medical), with salts (for example from Philips Medical, Toshiba), with gadolinium hyposulfite (for example from Kodak), with cadmium telluride (CT) or cadmium-zinc-telluride-(CZT) semiconductors, with yttrium oxyorthosilicate, with lutetium oxyorthosilicate, with sodium iodide or bismuth germanate. Especially good results are achieved with the so-called C(Z)T detectors, i.e., detectors that consist of a cadmium-(zinc)-telluride-(C(Z)T) semiconductor.

The design of an energy-dispersive detector, which is formed from a semiconductor, is described in detail in U.S. Pat. No. 5,434,417 A. In this case, segmented semiconductor strips that are irradiated from the front with the x-ray radiation are provided. The radiation is drawn through the semiconductor material until it interacts with the semiconductor material. The penetration depth depends on the energy of the x-ray photons. In the case of greater energy of the x-ray photons, the radiation is drawn through more deeply—until it interacts with the detector material and generates a current impulse by a photoelectric effect—than with lower energy of the x-ray photons. The current impulses can be discharged in the individual segments of the detector by means of applied electric contacts. The current impulses are processed with an input amplifier.

On the one hand, the detector can be designed in the form of a flat-bed detector. In this embodiment, all pixels are detected simultaneously and passed on to the correlation unit for evaluation. In this case, the detector consists of a large-area arrangement of individual detector sensors, preferably in a matrix that has rows and columns of such sensors.

In addition, a detector unit that is used to determine the emitted x-ray radiation and optionally to record an emission image and that for this purpose is designed with an x-ray-optical module for energy selection can also be provided.

Instead of the flat-bed detector, line detectors or a matrix of several detectors that are suitable for picking up an individual pixel can also be used. In the case of more recent detectors, the x-ray radiation from the object under examination is simultaneously sent via an x-ray fiber optic light guide. A number of such fiber optic light guides are combined in a surface detector.

In addition, the detector can be designed for picking up an individual pixel and can be movable so as to pick up all pixels. In this embodiment, the detector can detect only energy-dependent intensities in an individual pixel during the measurement. The intensities of the individual pixels are detected in succession, for example by lines, and are passed on to the correlation unit for further processing.

In addition, the detector can also have an array of detector sensors designed for picking up a pixel in each case and can be movable so as to pick up all pixels. According to this invention, both a line of detector sensors and another arrangement, for example a matrix-like arrangement, of detectors sensors, are defined as arrays of detector sensors. In this embodiment, the detector detects the intensity values in the individual pixels by lines or optionally also by blocks. To pick up all intensity values, the detector is preferably moved perpendicular to the main axis of the array during the measurement. The intensity values that are determined during the measurement are forwarded to the correlation unit.

For graphic display of, for example, the distribution of opacifying chemical elements in the object under examination, it is advantageous to detect the radiation intensities with, in each case, the same weighting, that are emitted by the respective space elements. In addition, for this purpose, it is also advantageous to load the respective space elements with, in each case, the same radiation intensity from the x-ray radiation source. In practice, these premises turn out to be only approximately correct, since, on the one hand, the irradiated x-ray radiation is attenuated by absorption to differing extents, depending on how much of the distance from the radiation lies in the object under examination, and, on the other hand, the radiation that is emitted by the space elements in the object under examination is attenuated by self-absorption to differing extents, depending on how much of the distance between them and the detector lies in the object under examination.

This problem occurs in all emission-spectroscopic methods. To solve the problem, the second intensity values are first corrected taking into consideration the absorption of irradiated x-ray radiation and/or the self-absorption of the emitted x-ray radiation in the object under examination, and the first and second intensity values are correlated with one another only after this correction, pixel for pixel. Such a correction can be performed by means of numerical processes by the geometry of the object under examination and an at least approximately position-dependent x-ray opacity being taken into consideration. To determine the position-dependent x-ray opacity, the images generated from the first intensity values can be used. To determine the position-dependent absorption and self-absorption, the position-dependent x-ray opacity that is obtained from this measurement can be taken as the baseline in a first approximation, since the absorption coefficients for the irradiated x-ray radiation is similar to that of the emitted radiation.

Because of the self-absorption of the emitted radiation, it may further be advantageous to move the position and angular position of the second detector during the measurement relative to the area of examination (ROI), for example on a circular segment pathway to offset structural inhomogeneities in the object under examination that have a varying absorbing action depending on the angle of observation and observation point. In this case, the graphic displays would be obtained after correction of the self-absorption was done by taking averages.

The signal that originates from the input amplifier is then sent into at least one correlation unit, with which the intensity of the detected x-ray radiation from a pixel of the object under examination is correlated with the image of the emitted x-ray radiation (x-ray scatter and x-ray fluorescence) of the same pixel. The correlation unit can be a correspondingly programmed data-processing unit.

To correlate the intensity values of the photons of the two modalities (transmission image and emission image), the latter are correlated with one another a pixel at a time, preferably subtracted from one another or divided by one another. To this end, in one case, a comparator can be used, and in the other case, a division term can be used for correlation that is performed pixel for pixel. Of course, other mathematical operations can also be performed for correlation of the intensity values of the transmitted and emitted x-ray radiation from an image.

To process the measured intensity values of a pixel, preferably the following devices that can be implemented in a data-processing unit are provided, namely:
d1. A first storage unit, with which the first intensity values of the transmitted x-ray radiation can be stored pixel for pixel,
d2. A second storage unit, with which the second intensity values of the emitted x-ray radiation can be stored pixel for pixel (e.g., with the elements I, Gd and Yb),
d3. A computing unit, which provides for a suitable correlation of the two generated image data sets and thus generates or computes an image data set from the information of the transmission data set and the data from the x-ray emission, preferably x-ray fluorescence.

As a result, it is possible to correlate the intensity values of all pixels in transmission and emission with one another, whereby the emission image is adapted via the characteristic emission lines to the contrast medium that is used. If a mixture that consists of x-ray contrast media (e.g., Ultravist® and Gadovist®) or substances that contain both iodine and a lanthanide (such as Gd or Dy) are used, the emission lines that are characteristic in each case can be used for emission imaging, whereby the measured data sets are then correlated with one another by pixels and are used for graphic display, or whereby alternatively, the respective intensity values are correlated with one another pixel for pixel, and the data that are obtained are then used for graphic display. To this end, the data that are obtained are delivered a pixel at a time to an output unit, which contains, for example, a monitor (CRT or LCD display) or a plotter.

For a more detailed explanation of the invention, the following figures and examples are used. To provide a direct illustration of how the invention works, in no case was any effort made to correct the measured x-ray spectra according to the absorption of the excitation beam and self-absorption. Here, in detail:

FIG. 1 shows an image of a test arrangement in a computer tomograph;

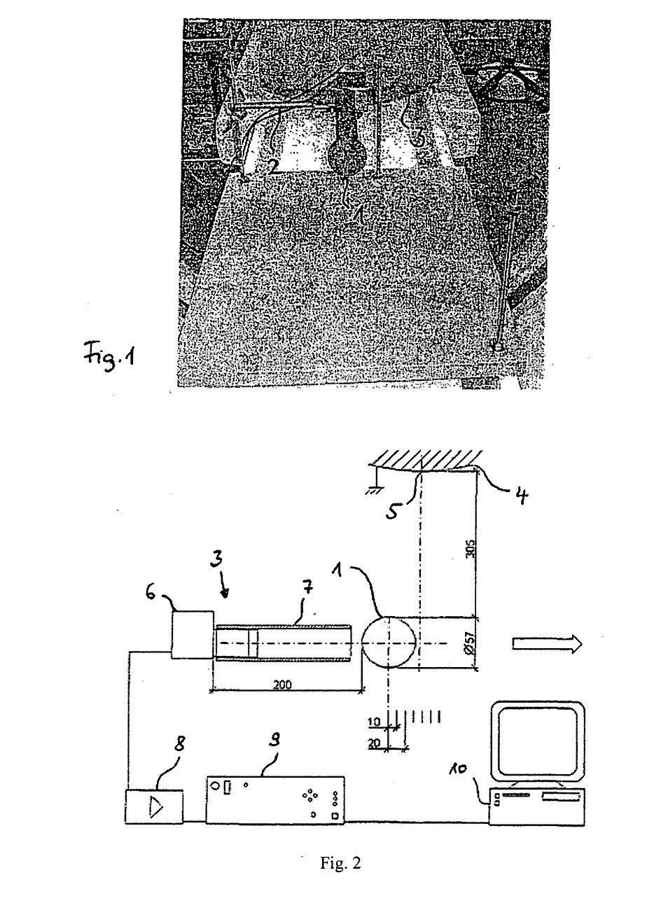

FIG. 2 shows a diagrammatic visualization of the imaging arrangement or of the experimental set-up;

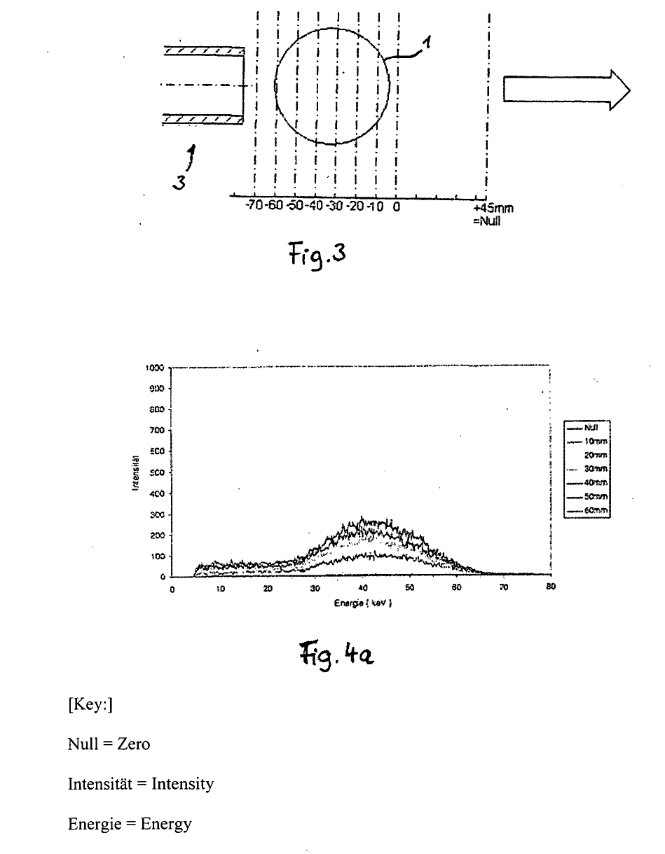

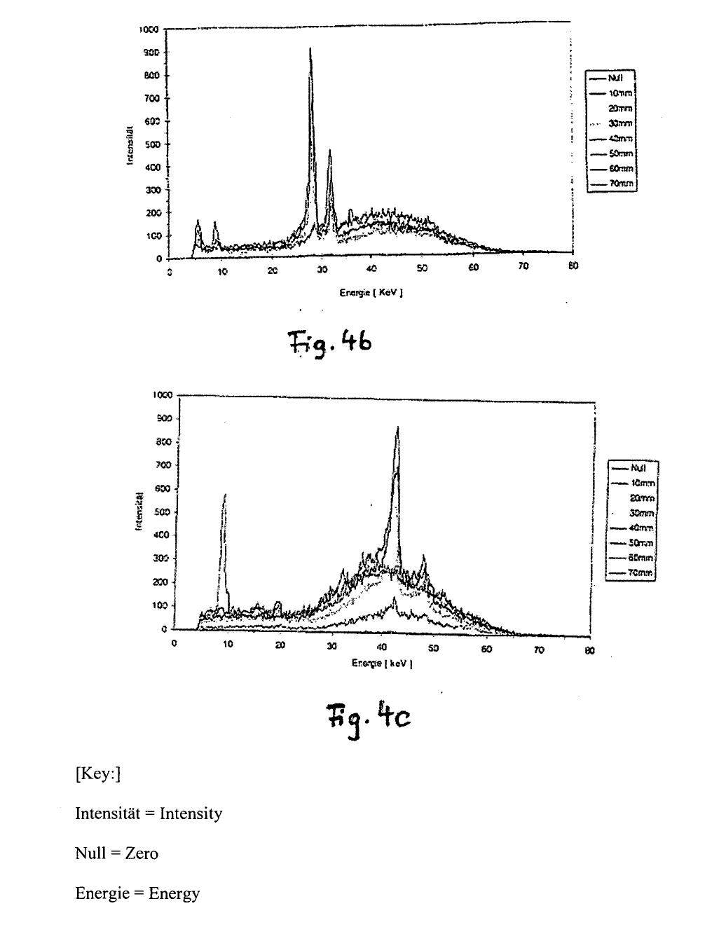

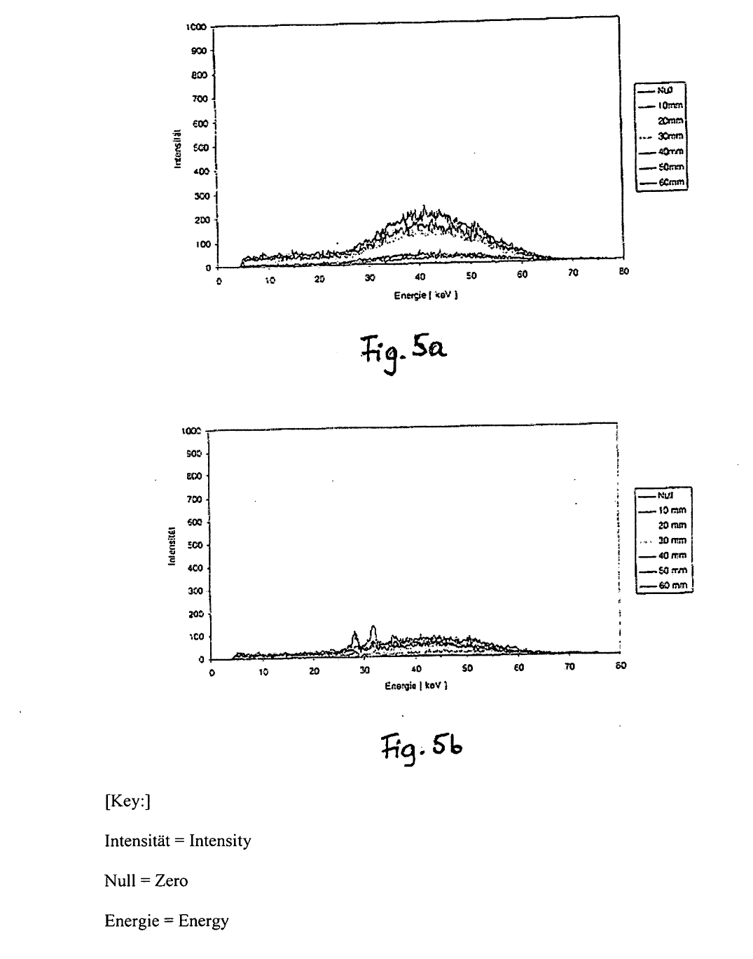

FIG. 3 shows a diagrammatic visualization of the test arrangement for generating the first phantom measurements;

FIG. 4 shows emission spectra of the phantom of FIG. 3, filled with water (FIG. 4a), Ultravist® (FIG. 4b), Gadovist® (FIG. 4c);

FIG. 5 shows emission spectra of the phantom of FIG. 3, filled with water (FIG. 5a), Ultravist® (FIG. 5b), Gadovist® (FIG. 5c), whereby in each case a PMMA disk that is 5 cm thick was arranged between the detector and the phantom;

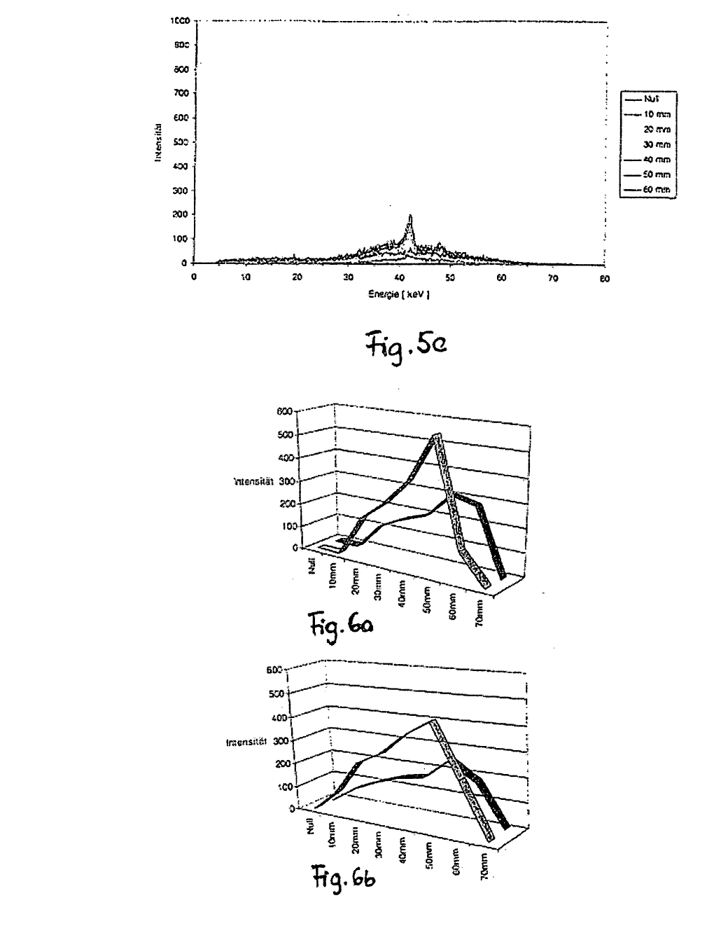

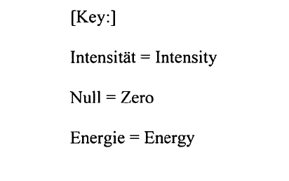

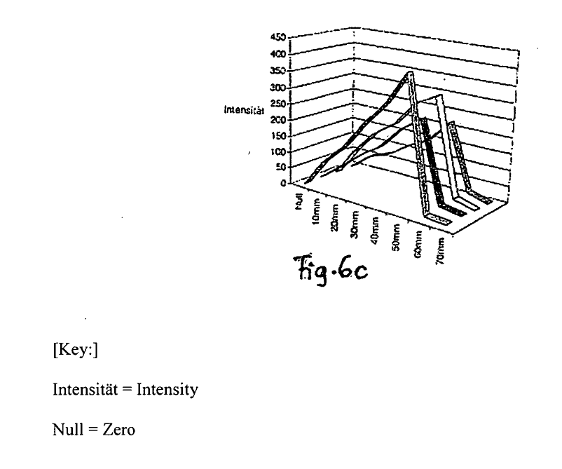

FIG. 6 shows the intensity of the emission based on the position/shift of the phantom from FIG. 3 in selected energy bands (corresponding to the K_{α} and K_{B} lines (iodine: FIG. 6a, gadolinium: FIG. 6b, mixture that consists of iodine and gadolinium: FIG. 6c);

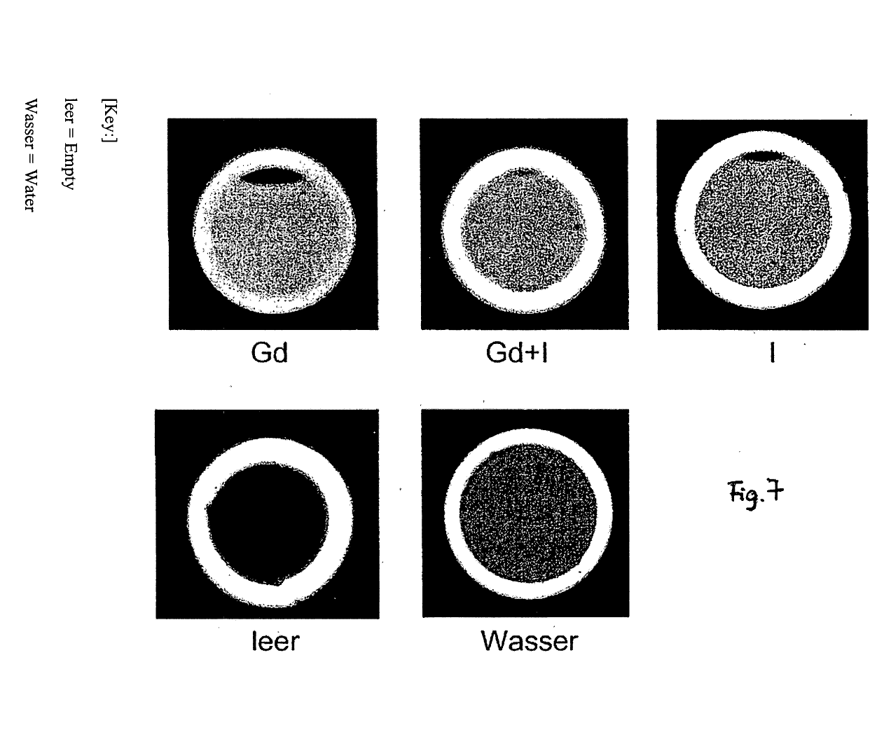

FIG. 7 shows CT cross-sectional images (transmission images) of the phantom filled with Gd, an iodine/Gd mixture, iodine, air and water.

In FIG. 1, a photographic visualization of a test arrangement in a computer tomograph with a rubber ball 1, which is fastened to a rack 2, is shown. The rubber ball is arranged in the center of the computer tomograph. In various tests, the rubber ball was filled with air, water, as well as different contrast medium solutions. The ball was found between the CT tubes (above the rubber ball; not shown) and a line detector (below the table that is visible under the rubber ball, not visible).

At an angle of 90° to the connecting line between the CT tubes, the rubber ball and the detector, a measuring chamber 3 was positioned for detection of the x-ray fluorescence. With this experimental set-up, a tissue, tumor or the like filled with contrast medium was simulated as an object under examination, which is examined in the computer tomograph. To this end, the object was scanned in layers, and in this case the scatter spectra were measured.

The experimental set-up used in this test is shown in detail in FIG. 2. The diagrammatic drawing shown there shows the ball 1, which is found as a phantom in the isocenter of the gantry 4. The CT tube 5 was arranged in the 12 o'clock position and remained fixed there. The measuring chamber 3, consisting of a detector 6 and a lead tube 7, was directed at an angle of 90° to the x-ray cone beam that protrudes from the CT tube to the phantom (ball) (in z-direction; see arrow).

To detect the x-ray radiation, a CZT detector 6 with a 3 mm×3 mm×2 mm cadmium-zinc-telluride crystal and 100/400 μm apertures was used (Amptek, Inc., USA). The data recorded by the fluorescence detector were conveyed from the detector via an amplifier to a multichannel analyzer 9 and then fed to an Excel® (Microsoft) spreadsheet, which was stored on a PC 10. The signal intensities SI=SI(E) were thus available in digital form as a function of the energy E.

In FIG. 3, a diagrammatic visualization of the test arrangement for generating the first phantom measurements is shown. A portion of the measuring chamber for measuring the fluorescence 3 can be seen to the left in the visualization, while the ball 1 is shown in the center of the visualization. The individual sectional planes that are perpendicular in FIG. 3, from which the fluorescence goes into the measuring chamber, were produced by an x-ray fan beam incident from above. The dotted lines mark the respective positions of the CT tubes above the image cutaway. The horizontal scale indicates the shift of the fan beam and thus indicates the sectional planes addressed in each case (excited layer) in the ball.

A “zero measurement” was made at +45 mm and thus outside of the excitation beam.

After each recording of a spectrum, the entire measuring structure was moved 10 mm further into the gantry (in the z-direction), and the new spectrum was recorded. Thus, various spectra were produced in layers based on the respective position of the ball in the beam or corresponding to the ball geometry.

With this measuring structure, the x-ray fluorescence thus could be measured based on the topography of the phantom, whereby at z=−60 mm, the layer closest to the detector was irradiated, and at z=0, the layer farthest from the detector was irradiated (at z=−60, the self-absorption of the emission is thus minimal and at z=0, it is maximal; because of the spherical geometry, an absorption effect in the irradiation is made noticeable at higher contrast medium concentrations).

### EXAMPLE 1

In a first measurement, the ball was filled with water and measured at 80 kV, 50 mA for each 80 s per position of the ball in the beam corresponding to FIG. 3 (parameters: detector: XR-100.CZT (aperture 0.1 mm), ball-detector distance: 18.0 cm; ball-CT tube distance: 32.0 cm).

In FIG. 4a, the scatter spectra of the water in the phantom are depicted for the various positions.

In a second measurement, the ball was filled with a solution of 50 mmol/l of iodine in water (Ultravist®) and measured at 80 kV, 50 mA for each 80 s per position (parameters: detector: XR-100.CZT (aperture 0.1 mm)).

The emission spectra obtained in the various positions are reproduced in FIG. 4b. The K_{α} and K_{B} lines of iodine (28.6 and 32.3 keV) can be seen clearly. From the graph, a dependency of the measured intensity of the x-ray fluorescence on the geometry of the phantom is clear. The larger the irradiated layer of the phantom was, the higher the measured intensity.

In a third measurement, the ball was filled with a solution of 50 mmol/l of gadolinium in water (Gadovist®) and measured at 80 kV, 50 mA for each 80 s per position (parameters: detector: XR-100.CZT (aperture 0.1 mm)).

The emission spectra obtained in the various positions are reproduced in FIG. 4c. The K_{α} and K_{β}lines of gadolinium (43.0 and 48.7 keV) can be seen clearly. It was shown that the intensity of the measured emission radiation especially in the range of the K lines depends on the geometry of the ball in the radiation field.

### EXAMPLE 2

In the individual measurements of this test, in each case a 5 cm thick PMMA disk was positioned as a filter between the detector and the phantom to simulate the self-absorption of the x-ray fluorescence radiation through the surrounding tissue.

In FIG. 5a, the scatter spectra of the water in the phantom are depicted for the various positions.

In a second measurement, the ball was filled with a solution of 50 mmol/l of iodine in water (Ultravist®) and measured at 80 kV, 50 mA for each 80 s per position (parameters: detector: XR-100.CZT (aperture 0.1 mm)).

The emission spectra obtained in the various positions are reproduced in FIG. 5b. The intensity of the fluorescence radiation decreased because of the inserted PMMA disk. It was verified that the intensity was all the lower the thicker the disk was. However, even in the largest layer of the ball (in the center), the K lines were still measurable.

In a third measurement, the ball was filled with a solution of 50 mmol/l of gadolinium in water (Gadovist®) and measured at 80 kV, 50 mA for each 80 s per position (parameters: detector: XR-100.CZT (aperture 0.1 mm)).

The emission spectra obtained in the various positions are reproduced in FIG. 5c. Also here, the fluorescence radiation decreased because of the inserted PMMA disk. Since the K_{α} and K_{B} lines of gadolinium are approximately 43.0 or 48.7 keV, a considerably more intensive fluorescence radiation could be detected with the presence of the 5 cm-thick PMMA disk than in the case of the iodine emission as before. Therefore, even in this case, the K lines can still be measured in the largest layer of the ball (in the center).

### EXAMPLE 3

In another test, the intensity values of the fluorescence were determined and recorded based on the positioning of the ball relative to the x-ray beam.

In a first measurement, the ball was filled with a solution of 50 mmol/l of iodine in water (Ultravist®) and measured at 80 kV, 50 mA for each 80 s per position.

In FIG. 6a, the intensity of the fluorescence radiation is plotted based on the position/shift of the phantom in selected energy bands corresponding to the K_{α} line of iodine at 28.6 keV and the K_{β} line of iodine at 32.3 keV. The profile of the emission intensity produced by the shape of the ball can be detected from this figure.

In a second measurement, the ball was filled with a solution of 50 mmol/l of gadolinium in water (Gadovist®) and measured at 80 kV, 50 mA for each 80 s per position.

In FIG. 6b, the intensity of the fluorescence radiation is plotted based on the position/shift of the phantom in selected energy bands corresponding to the K_{α} line of gadolinium at 43.0 keV and the K_{β} line of gadolinium at 48.7 keV. The profile of the emission intensity produced by the shape of the ball can also be detected from this figure.

In a third measurement, the ball was filled with a solution of 25 mmol/l of iodine (Ultravist®) and 25 mmol/l of gadolinium in water (Gadovist®) and measured at 80 kV, 50 mA for each 80 s per position.

In FIG. 6c, the intensity of the fluorescence radiation is plotted based on the position/shift of the phantom in selected energy bands corresponding to the K₆₀ line of iodine at 28.7 keV, the K_{β} line of iodine at 32.3 keV, the K_{α} line of gadolinium at 43.0 keV, and the K_{β}line of gadolinium at 48.7 keV. As can be seen in FIG. 6c, the ball profile is only insufficiently reproduced in the direct plotting of the signal intensity as a function of the position. This can be attributed to the absorption on the excitation side and the self-absorption on the emission side, which distort the image. Lower contrast medium concentrations and corrections of the absorption of the primary beam and self-absorption of the x-ray fluorescence resulted in a graphic visualization of the ball in one dimension.

### EXAMPLE 4

FIG. 7 shows the CT cross-sectional images that are recorded in the preceding examples of the x-ray fluorescence. From the top left to the bottom right, the ball that is filed with gadolinium, the ball with the mixture that consists of gadolinium and iodine, the ball with iodine, the ball with pure water, and the ball filled with air can be seen. The air-filled ball has clearly the smallest x-ray attenuation, followed by the water-filled ball. When using the ball with 50 mmol/l of opacifying element, the x-ray attenuation is more pronounced than that with water; a quantitative evaluation is possible via the determination of the Hounsfield units (HU), but only the addition of the x-ray fluorescence images allows an assessment on the element-specific filling of the ball.

1. X-Ray arrangement for graphic display of an object under examination that contains at least one radiopaque chemical element by means of x-ray radiation that is transmitted through the object under examination and that is emitted from the latter, comprising:
a. At least one x-ray radiation source that emits essentially polychromatic x-ray radiation,
b. A first detector or a first detector unit, with which values of a first intensity of the x-ray radiation that is transmitted through the object under examination can be determined,
c. A second detector or a second detector unit, with which values of a second intensity of the x-ray radiation that is emitted from the object under examination can be determined,
d. At least one correlation unit, with which the first intensity values of the transmitted x-ray radiation can be correlated with one another with the second intensity values of the emitted x-ray radiation, pixel for pixel, and
e. At least one output unit for visualizing the object under examination from the pixel signals that can be obtained by correlation of the first intensity values with the second intensity values.

2. X-ray arrangement according to claim 1, characterized in that the correlation unit has the following devices:
d1. A first storage unit, with which the first intensity values of the transmitted x-ray radiation can be stored pixel for pixel,
d2. A second storage unit, with which the second intensity values of the emitted x-ray radiation can be stored pixel for pixel,
d3. A computing unit, with which the first intensity values of the transmitted x-ray radiation can be correlated with one another with the second intensity values of the emitted x-ray radiation pixel for pixel.

3. X-Ray arrangement according to claim 1, wherein the second intensity values can be detected in resolved form based on the energy of the emitted x-ray radiation.

4. X-Ray arrangement according to claim 1, wherein with the second detector or with the second detector unit, x-ray radiation emitted by the opacifying chemical element contained in the object under examination can be discriminated from the other emitted x-ray radiation with the aid of the energy thereof.

5. X-Ray arrangement according to claim 1, wherein the first intensity values and the second intensity values can be correlated with one another pixel for pixel according to a previous correction taking into consideration the absorption of irradiated x-ray radiation and/or the self-absorption of the emitted x-ray radiation in the object under examination.

6. X-Ray arrangement according to claim 1, wherein the first and/or the second detector is a flat-bed detector.

7. X-Ray arrangement according to claim 1, wherein the first and/or the second detector is designed to pick up an individual pixel and can be moved to pick up all pixels.

8. X-Ray arrangement according to claim 1, wherein a detector unit that is designed with an x-ray-optical module for energy selection is provided to detect the emitted x-ray radiation.

9. X-Ray arrangement according to claim 1, wherein the first and/or the second detector has an array of detector sensors that are designed to pick up a pixel in each case and can be moved to pick up all pixels.

10. X-Ray arrangement according to claim 1, in the radiological finding in combination with other radiological methods of imaging, such as positron-emission tomography (PET), single-photon-emission-computer tomography (SPECT) and sonography, as well as methods of optical imaging.

11. Use of the x-ray arrangement according to claim 1 for graphic display of an object under examination that contains at least one opacifying chemical element by means of x-ray radiation that is transmitted by the object under examination and is emitted from the latter.

12. Use of the x-ray arrangement according to claim 11, wherein the following process steps are performed:
a. Irradiation of the object under examination with essentially polychromatic x-ray radiation,
b. Determination of values of a first intensity of the x-ray radiation that is transmitted through the object under examination,
c. Determination of values of a second intensity of the x-ray radiation that is emitted by the object under examination,
d. Correlation of the first intensity values of the transmitted x-ray radiation, pixel for pixel, with the second intensity values of the emitted x-ray radiation, and
e. Visualization of the object under examination from pixel signals that are obtained by correlation of the first intensity values with the second intensity values.

13. Use of the x-ray arrangement according to claim 11, wherein the second intensity values can be measured in resolved form based on the energy of the emitted x-ray radiation.

14. Use of the x-ray arrangement according to claim 11, wherein x-ray radiation that is emitted from the opacifying chemical element contained in the object under examination is discriminated from other emitted x-ray radiation with the aid of the energy thereof.

15. Use of the x-ray arrangement according to claim 11, wherein the first intensity values and the second intensity values are correlated with one another pixel for pixel according to a previous correction taking into consideration the absorption of irradiated x-ray radiation and/or the self-absorption of the emitted x-ray radiation in the object under examination.

16. Use of the x-ray arrangement according to claim 11, wherein a first and a second detector or a first and a second detector unit are provided.

17. Use of the x-ray arrangement according to claim 16, wherein the first and/or the second detector is a flat-bed detector.

18. Use of the x-ray arrangement according to claim 16, wherein the first and/or the second detector is designed to pick up an individual pixel and is moved to pick up all pixels.

19. Use of the x-ray arrangement according to claim 16, wherein the first and/or the second detector has an array of detector sensors designed to pick up a pixel in each case and is moved to pick up all pixels.

20. Use of the x-ray arrangement according to claim 16, wherein a detector unit that is designed with an x-ray-optical module for energy selection is provided to detect the emitted x-ray radiation.

21. Use of the x-ray arrangement according to claim 11, wherein the opacifying chemical element is selected from a group that comprises bromine, iodine, lanthanides and bismuth.

22. Use of the x-ray arrangement according to claim 11, wherein the opacifying chemical element is administered enterally or parenterally.

23. Use of the x-ray arrangement according to claim 11 for element-specific graphic or quantitative display of an area of examination in the object under examination that contains at least one opacifying chemical element.

24. Use of the x-ray arrangement according to claim 11 in the radiological finding in combination with other radiological methods for imaging, such as positron-emission tomography (PET), single-photon-emission-computer tomography (SPECT) and sonography, as well as methods of optical imaging.

25. Imaging x-ray contrast process on an object under examination by means of x-ray radiation that is transmitted by the object under examination and emitted from the latter, comprising the following process steps:
a. Irradiation of the object under examination with essentially polychromatic x-ray radiation,
b. Determination of values of a first intensity of the x-ray radiation that is transmitted through the object under examination,
c. Determination of values of a second intensity of the x-ray radiation that is emitted by the object under examination,
d. Correlation of the first intensity values of the transmitted x-ray radiation, pixel for pixel, with the second intensity values of the emitted x-ray radiation, and
e. Visualization of the object under examination from pixel signals that are obtained by correlation of the first intensity values with the second intensity values.

26. X-Ray contrast process according to claim 25, wherein first at least one radiopaque chemical element is administered to the object under examination before process steps a) to e) are performed.

27. X-Ray contrast process according to claim 25, wherein the second intensity values can be measured in resolved form based on the energy of the emitted x-ray radiation.

28. X-Ray contrast process according to claim 25, wherein x-ray radiation emitted from the opacifying chemical element contained in the object under examination is discriminated from the other emitted x-ray radiation with the aid of the energy thereof.

29. X-Ray contrast process according to claim 25, wherein the first intensity values and the second intensity values are correlated with one another pixel for pixel according to a preceding correction taking into consideration the absorption of irradiated x-ray radiation and/or the self-absorption of the emitted x-ray radiation in the object under examination.

30. X-Ray contrast process according to claim 25, wherein a first and a second detector or a first and a second detector unit are provided.

31. X-Ray contrast process according to claim 30, wherein the first and/or the second detector is a flat-bed detector.

32. X-Ray contrast process according to claim 30, wherein the first and/or the second detector is designed to pick up an individual pixel and is moved to pick up all pixels.

33. X-Ray contrast process according to claim 30, wherein the first and/or the second detector has an array of detector sersors designed to pick up, in each case, a pixel and is moved to pick up all pixels.

34. X-Ray process according to claim 30, wherein a detector unit that is designed with an x-ray-optical module for energy selection is provided to determine the emitted x-ray radiation.

35. X-Ray contrast process according to claim 25, wherein the opacifying chemical element is selected from a group that comprises bromine, iodine, lanthanides and bismuth.

36. X-Ray contrast process according to claim 25, wherein the opacifying chemical element is administered enterally or parenterally.

37. X-Ray contrast process according to claim 25 in the radiological finding in combination with other radiological methods for imaging, such as positron-emission tomography (PET), single-photon-emission-computer tomography (SPECT) and sonography, as well as methods of optical imaging.
